(19) United States
(12) Patent Application Publication
(10) Pub. No.: US 2026/0321228 A1
(43) Pub. Date: Oct. 15, 2026

(54) GUITARS AND METHODS OF MANUFACTURING THE SAME

(71) Applicant: Leo Elliot ROSE, New Milford, CT (US)

(72) Inventor: Leo Elliot ROSE, New Milford, CT (US)

(21) Appl. No.: 19/179,319

(22) Filed: Apr. 15, 2025

(51) Int. Cl. G10D 3/06; G10D 1/08; G10D 3/22

(52) U.S. Cl. CPC G10D 3/06; G10D 1/085; G10D 3/22

(57) ABSTRACT

A guitar neck includes a main body extending from a first end to a second end. A cross-section of at least one portion of the main body includes a first surface and a second surface. The first surface is relatively flat and extends from a first edge to a second edge. The second surface extends from the first edge to the second edge. The second surface includes a first convex curvature extending from the first edge to a midpoint between the first edge and the second edge, a second convex curvature extends from the midpoint to a first point between the midpoint and the second edge, and a third convex curvature extending from the first point to the second edge.

### TECHNICAL FIELD

The present disclosure relates to guitars and methods of manufacturing the same.

### BACKGROUND

Guitars are stringed musical instruments that commonly include six strings. Generally, guitars include a neck and a body. The body of a guitar is generally held against a user to enable the user to strum or pluck the strings with one hand while the user's other hand is used to press the strings into the neck of the guitar to play desired notes.

### SUMMARY

At least one example embodiment relates to a guitar neck including a main body extending from a first end to a second end. A cross-section of at least one portion of the main body may include a first surface and a second surface. The first surface may be relatively flat and may extend from a first edge to a second edge. The second surface may extend from the first edge to the second edge and may include a first convex curvature extending from the first edge to a first point between the first edge and the second edge, a second convex curvature extending from the first point to a second point between the first point and the second edge, and a third convex curvature extending from the second point to the second edge.

In at least one example embodiment, the second point may be a concave curvature between the second convex curvature and the third convex curvature.

In at least one example embodiment, the cross-section of the at least one portion of the main body may further include an imaginary fourth convex curvature, the imaginary fourth convex curvature may extend from the first point between the first edge and the second edge to the second edge, and the second point may be about 0.07 inches from a tangent line of the imaginary fourth convex curvature. The tangent line may be perpendicular to a normal line that extends through the second point.

In at least one example embodiment, the second point may be about 0.169 inches from the first point between the first surface and the second surface.

In at least one example embodiment, the second point may be about 0.4 inches from the first point between the first edge and the second edge.

In at least one example embodiment, the first edge may be proximate to where bass strings will be placed and the second edge may be proximate to where treble strings will be placed.

In at least one example embodiment, the at least one portion of the main body may be proximate to a location of a first fret.

Also described herein is a guitar. The guitar may include a headstock, a body, and a neck. The neck may include a main body extending from the headstock to the body. A cross-section of at least one portion of the main body may include a first surface and a second surface. The first surface may be relatively flat and may extend from a first edge to a second edge. The second surface may extend from the first edge to the second edge and may include a first convex curvature extending from the first edge to a first point between the first edge and the second edge, a second convex curvature extending from the first point to a second point between the first point and the second edge, and a third convex curvature extending from the second point to the second edge.

In at least one example embodiment, the second point may be a concave curvature between the second convex curvature and the third convex curvature.

In at least one example embodiment, the cross-section of the at least one portion of the main body may further include an imaginary fourth convex curvature, the imaginary fourth convex curvature may extend from the first point between the first edge and the second edge to the second edge, and the second point may be about 0.07 inches from a tangent line of the imaginary fourth convex curvature. The tangent line may be perpendicular to a normal line that extends through the second point.

In at least one example embodiment, the second point may be about 0.169 inches from the first point between the first surface and the second surface.

In at least one example embodiment, the second point may be about 0.4 inches from the first point between the first edge and the second edge.

In at least one example embodiment, the first edge may be proximate to where bass strings will be placed and the second edge may be proximate to where treble strings will be placed.

In at least one example embodiment, at least one of the body may include one or more portions that are hollow or the headstock may be slotted.

In at least one example embodiment, the second convex curvature may be larger than the first convex curvature and the third convex curvature and the third convex curvature may be greater than the first convex curvature.

In at least one example embodiment, the body may include a bass side and a treble side, the bass side being smaller than the treble side.

Also described herein is a method of manufacturing a neck of a guitar. The method of manufacturing may include obtaining a piece of wood, forming a first surface, and forming a second surface. The first surface may be relatively flat. The second surface may be opposite the first surface and may be formed by forming a first convex curvature extending from a first edge to a first point between the first edge and a second edge, forming a second convex curvature extending from the first point to a second point between the first point and the second edge, and forming a third convex curvature extending from the second point to the second edge.

In at least one example embodiment, forming the second convex curvature may further include forming a concave curvature between the second convex curvature and the third convex curvature.

In at least one example embodiment, the second point may be about 0.4 inches from the first point between the first edge and the second edge, about 0.169 inches from the first point between the first surface and the second surface, and about 0.07 inches from a tangent line of an imaginary fourth convex curvature. The imaginary fourth convex curvature may extend from the first point between the first edge and the second edge to the second edge and the tangent line may be perpendicular to a normal line that extends through the second point.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a perspective view of a guitar in accordance with at least one example embodiment.

FIG. 2 is a top perspective view of a neck of the guitar of FIG. 1 in accordance with at least one example embodiment.

FIG. 3 is a first bottom perspective view of the neck of the guitar of FIG. 2 in accordance with at least one example embodiment.

FIG. 4 is a second bottom perspective view of the neck of the guitar of FIG. 2 in accordance with at least one example embodiment.

FIG. 5 is a cross-section of the neck of the guitar of FIG. 2 in accordance with at least one example embodiment.

FIG. 6 is a flow chart of a method of manufacturing a neck of a guitar in accordance with at least one example embodiment.

FIG. 7 is a flow chart of a method of forming a second surface of the neck of the guitar in accordance with at least one example embodiment.

### DETAILED DESCRIPTION OF EXAMPLE EMBODIMENTS

Some detailed example embodiments are disclosed herein. However, specific structural and functional details disclosed herein are merely representative for purposes of describing some example embodiments. Example embodiments may, however, be embodied in many alternate forms and should not be construed as limited to only example embodiments set forth herein.

Accordingly, while example embodiments are capable of various modifications and alternative forms, example embodiments thereof are shown by way of example in the drawings and will herein be described in detail. It should be understood, however, that there is no intent to limit an example embodiment to the particular forms disclosed, but to the contrary, example embodiments are to cover all modifications, combinations, equivalents, and alternatives falling within the scope of an example embodiment. Like numbers refer to like elements throughout the description of the figures.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiment.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the apparatus in use or operation in addition to the orientation depicted in the figures. For example, if the apparatus in the figures is turned over, elements described as “below” or “beneath” other elements or features would then be oriented “above” the other elements or features. Thus, the term “below” may encompass both an orientation of above and below. The apparatus may be otherwise oriented (rotated 90 degrees or at other orientations) and the spatially relative descriptors used herein interpreted accordingly.

The terminology used herein is for the purpose of describing various example embodiment only and is not intended to be limiting of example embodiment. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements and/or groups thereof.

Example embodiments are described herein with reference to cross-sectional illustrations that are schematic illustrations of example embodiment. As such, variations from the shapes of the illustrations are to be expected. Thus, example embodiment should not be construed as limited to the shapes of regions illustrated herein but are to include deviations and variations in shapes.

When the words “about” and “substantially” are used in this specification in connection with a numerical value, it is intended that the associated numerical value include a tolerance of ±10% around the stated numerical value, unless otherwise explicitly defined. Moreover, when the terms “generally” or “substantially” are used in connection with geometric shapes, it is intended that precision of the geometric shape is not required but that latitude for the shape is within the scope of the disclosure. Furthermore, regardless of whether numerical values or shapes are modified as “about,” “generally,” or “substantially,” it will be understood that these values and shapes should be construed as including a manufacturing or operational tolerance (e.g., ±10%) around the stated numerical values or shapes.

Unless otherwise defined, all terms (including technical and scientific terms) used herein have the same meaning as commonly understood by one of ordinary skill in the art to which example embodiment belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

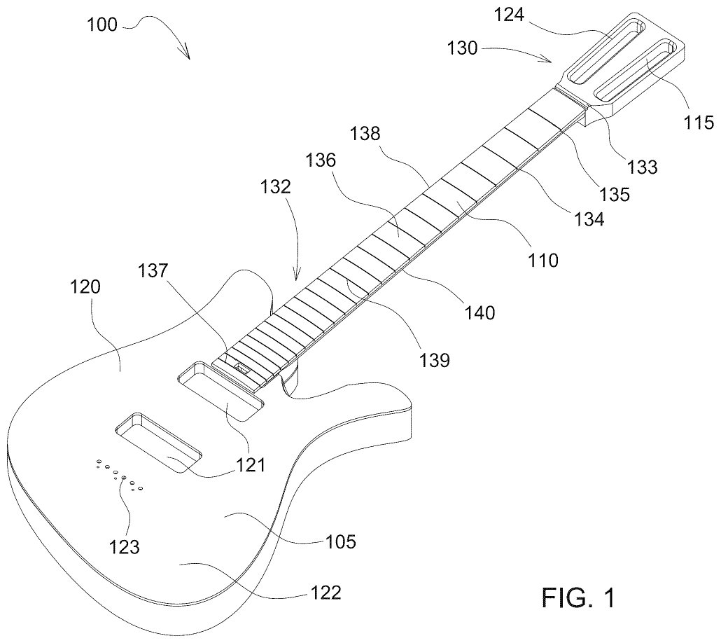

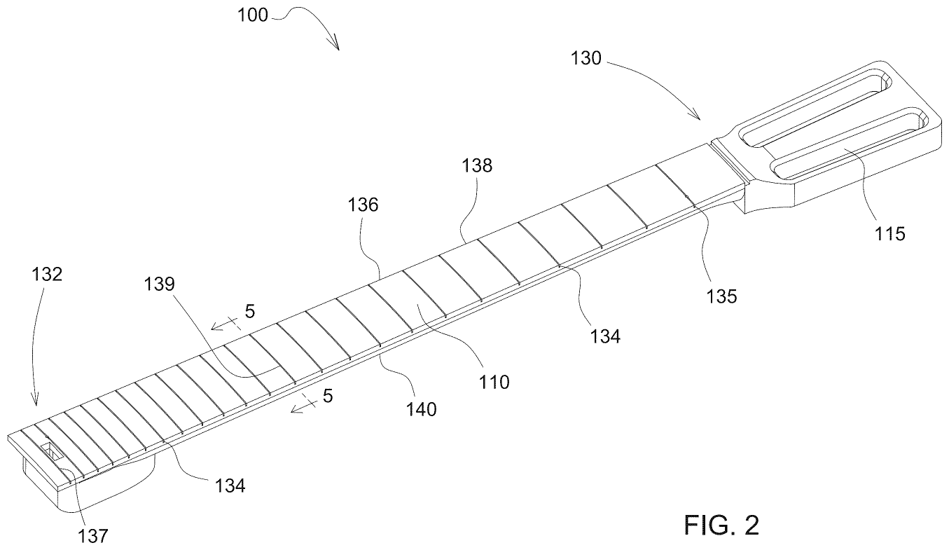

FIG. 1 is a perspective view of a guitar 100. The guitar 100 includes a body 105, a neck 110, and a headstock 115. FIGS. 2-4 are various perspective views of the neck 110 of the guitar 100. While not shown in FIG. 1, a plurality of strings may extend along the neck 110 from the headstock 115 to the body 105. In at least one example embodiment, a guitar may include six strings although example embodiments are not limited herein. In at least one example embodiment, the strings that may be attached to the guitar may vary and may be used to play a variety of notes ranging from low notes to high notes. The strings responsible for creating lower notes are referred to herein as bass strings and the strings responsible for creating higher notes are referred to herein as treble strings. The strings may be placed along the neck 110 from the headstock 115 to the body 105 with the bass strings on one side of the neck 110 and the treble strings on an opposite side of the neck 110. Additional details of the neck 110 are described herein.

The body 105 of the guitar 100 may include a bass side 120 and a treble side 122. The bass side 120 may be a portion of the guitar 100 closest to bass strings of the guitar 100 and the treble side 122 may be a portion of the guitar 100 closest to treble strings of the guitar 100. In at least one example embodiment, the bass side 120 of the guitar 100 may be closest to a user or musician's head when the guitar 100 is being played. In at least one example embodiment, the bass side 120 of the guitar 100 may be smaller than the treble side 122 of the guitar 100. For example, the treble side 122 of the guitar 100 may have an area from the neck 110 to an edge of the guitar that is wider than an area from the neck 110 to an edge of the guitar defining the bass side 120 of the guitar 100.

In at least one example embodiment, the body 105 of the guitar 100 may include one or more portions that are hollow which may help to reduce a weight of the guitar 100. In at least one example embodiment, the body 105 may semi-hollow with no material removed in areas of the body 105 proximate to pickup locations 121 or a bridge location 123 of the guitar 100. The bridge location 123 may be a location on the body 105 where a bridge is located. A bridge of a guitar is configured to regulate height and placement of strings of the guitar relative to the body. The pickup locations 121 are locations where pickups of the guitar are located. Pickups of a guitar may influence a guitar's sound by creating magnetic fields which may be disrupted by strings of the guitar when the guitar is being played. Bridges and pickups are generally well known in the art and a further discussion of these elements not included herein. The portion of the body 105 of the guitar 100 that may be hollowed out is not near either the pickup locations 121 or the bridge location 123 to ensure that the sound of the guitar 100 is not impacted by the hollowed portions of the body 105.

The headstock 115 of the guitar 100 may be coupled to the neck 110 of the guitar 100 opposite the body. In at least one example embodiment, the headstock 115 may be slotted. A slotted headstock may include one or more openings 124 that may help to reduce the weight of the guitar 100.

The neck 110 of the guitar 100 may include a main body with a first end 130 coupled to the headstock 115 and a second end 132 coupled to the body 105 of the guitar 100. The neck 110 may include a nut 133 proximate to where the neck 110 couples to the headstock 115. The nut 133 may be approximately 1.625 inches wide in at least one example embodiment. However, dimensions of the nut 133 are not limited herein. The neck 110 extends in a longitudinal direction from the first end 130 to the second end 132. The neck 110 extends in a lateral direction from a first edge 138 to a second edge 140. The first edge 138 of the neck 110 may be proximate to the bass strings of the guitar and the second edge 140 may be proximate to the treble strings of the guitar as described above. The neck 110 may include a plurality of frets 134 arranged along a first surface 136 of the neck 110 in the longitudinal direction from the headstock 115 to the body 105, each fret 134 extending across the neck 110 in the lateral direction. The plurality of frets 134 may include a first fret 135 proximate to the headstock 115 of the guitar 100 and a final fret 137 proximate to the body 105 of the guitar 100. A twelfth fret 139 may be disposed between the first fret 135 and the final fret 137. In at least one example embodiment, the neck 110 may have a width of about 1.953 inches at the twelfth fret 139. However, dimensions of the neck 110 are not limited herein.

The first surface 136 may be relatively flat. For example, the first surface may have a slight curvature with a radius of between about 7.5 inches and 20 inches in the lateral direction. The first surface 136 may be considered relatively flat when compared to the opposite surface of the neck 110 which will be described in further detail herein. The first surface 136 may extend in the lateral direction from the first edge 138 to the second edge 140. The first edge 138 may be proximate to where the bass strings will be placed and the second edge 140 may be proximate to where treble strings will be placed.

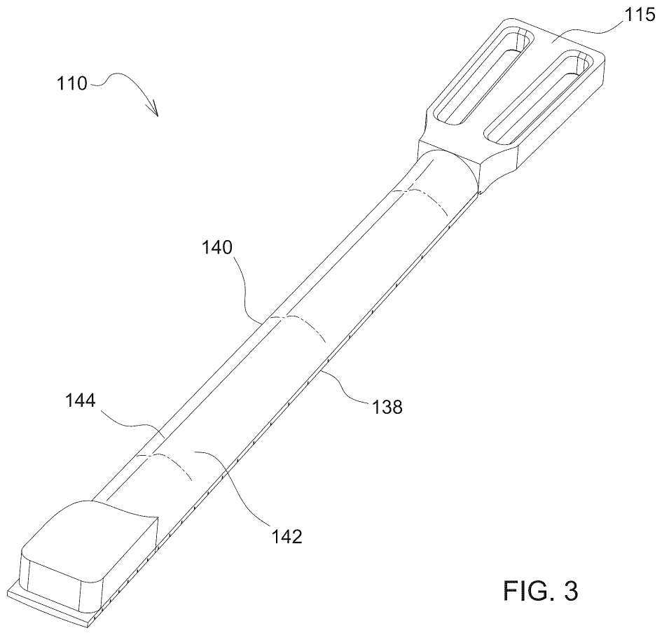

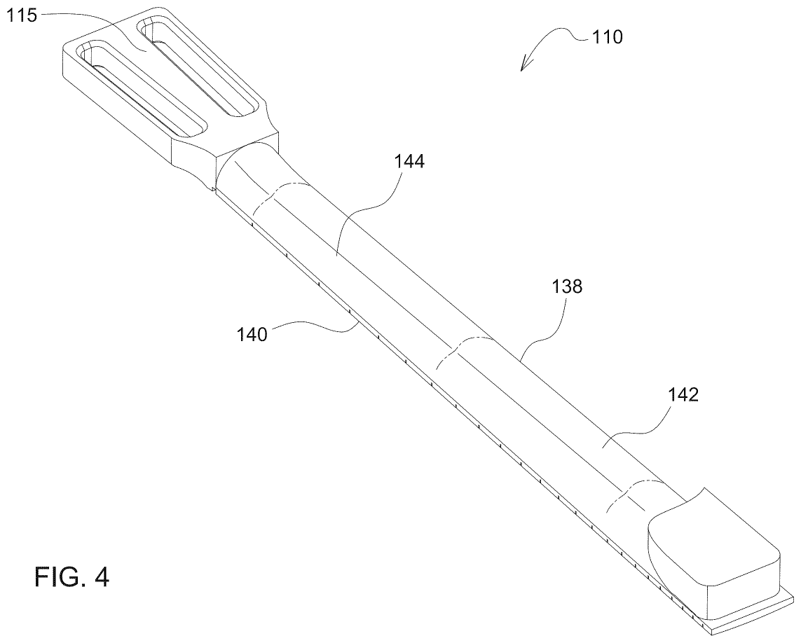

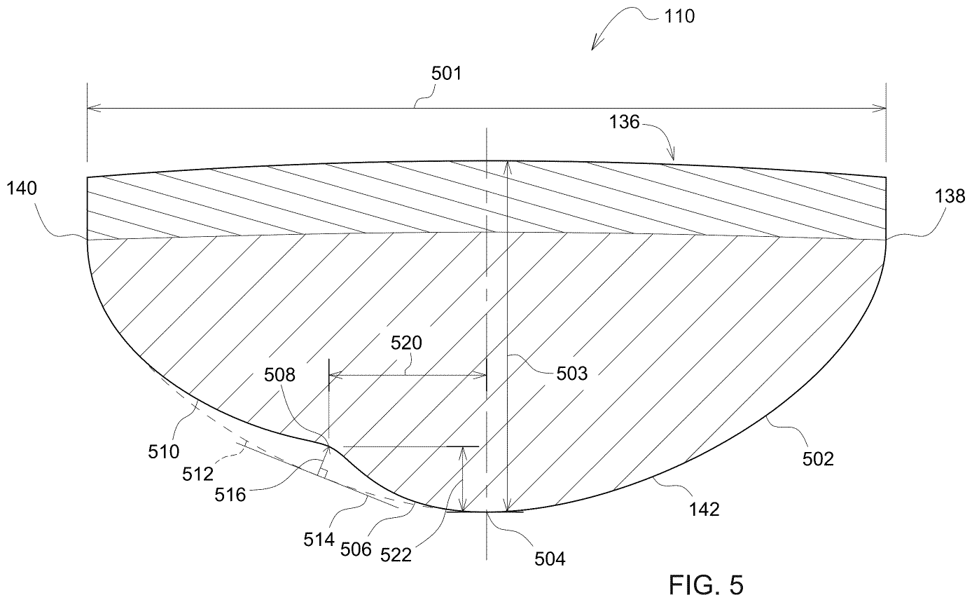

As shown in FIGS. 3-4, the neck 110 may also include a second surface 142 opposite the first surface 136. The second surface 142 also extends in the lateral direction from the first edge 138 to the second edge 140. The second surface 142 may be curved or rounded and may include an indentation 144 along a length of the neck 110. The indentation 144 may also be considered a groove, divot, or other descriptor defining a portion of the second surface 142 of the neck 110 that interrupts what would otherwise be a uniform or smooth convex curvature of the second surface 142. Further details of the indentation 144 are described below with reference to FIG. 5.

In at least one example embodiment, the neck 110 may have a thickness from the first surface 136 to the second surface 142 of about 18 mm at the first fret 135 and a thickness of about 21 mm at the twelfth fret 139. However, dimensions of the neck 110 are not limited herein.

The indentation 144 is configured to create a neck 110 that is more ergonomic for the guitar 100 than a neck 110 that does not include the indentation 144 and instead has a second surface with a convex curvature. For example, the indentation 144 allows for a user's wrist to collapse when playing the guitar 100 which may allow heads of the metacarpals, portions of the hand where the fingers begin, to jut or press against the neck and may allow for a user's thumb to extend further around the neck. This may provide a more ergonomic way to play the guitar 100 which may improve experience of a user when playing the guitar 100.

FIG. 5 is a cross-section of at least one portion of the main body of the neck 110 of the guitar 100 taken along line 5-5 as shown in FIG. 2. The cross-section shown in FIG. 5 may be a cross-section at or around the twelfth fret 139. The second surface 142 may extend from the first edge 138 to the second edge 140 as described above. In at least one example embodiment, a width 501 from the first edge 138 to the second edge 140 may be about 2 inches. At a location of the first fret 135, the width 501 may be about 1.5 inches. The width 501 of the neck 110 at another cross-section along the length of the neck 110 from the headstock 115 to the body 105 of the guitar 100 may be between about 1.5 inches and 3 inches. Further, a thickness 503 of the neck 110 at or around the twelfth fret 139 may be about 0.865 inches. The thickness 503 of a thickest portion of the neck 110 at or around a location of the first fret may be about 0.65 inches and the thickness 503 of the thickest portion of the neck 110 along another cross-section along the length of the neck 110 from the headstock 115 to the body 105 of the guitar 100 may be between about 0.65 inches and 1.25 inches. However, example embodiments are not limited herein. The second surface 142 may include a first convex curvature 502 that may extend from the first edge 138 to a first point 504 between the first edge 138 and the second edge 140. In at least one example embodiment, the first point 504 may be a portion along the second surface 142 that is furthest from the first surface 136. In at least one example embodiment, the first point 504 may be a midpoint between the first edge 138 and the second edge 140.

The second surface 142 may additionally include a second convex curvature 506 extending from the first point 504 to a second point 508. The second point 508 is located between the first point 504 and the second edge 140. The second surface 142 may further include a third convex curvature 510 extending from the second point 508 to the second edge 140.

In at least one example embodiment, the second point 508 may include the indentation 144 described above. In at least one example embodiment, the second point 508 may be a point along a concave curvature between the second convex curvature 506 and the third convex curvature 510. The second point 508 may be a deepest point of the concave curvature. Thus, the second point 508 may be a location of the concave curvature located closest to the first surface 136. In at least one example embodiment, the second point 508 may be located a first distance 520 from the first point 504 towards the second edge 140. In at least one example embodiment, the first distance 520 may be about 0.4 inches. In at least one example embodiment, the first distance 520 may be located about 0.125 inches from the first point 504 towards the second edge 140 for a cross-section of the neck 110 located at or around the first fret 135 and the first distance 520 at another cross-section along the length of the neck 110 from the headstock 115 to the body 105 of the guitar 100 may be between about 0.125 inches and 0.875 inches. In at least one example embodiment, the second point 508 may be located a second distance 522 from the first point 504 towards the first surface 136. The second distance 522 may be about 0.169 inches in at least one example embodiment. The second distance 522 may be about 0.125 inches at or around the first fret 135 and the second distance 522 at another cross-section along the length of the neck 110 from the headstock 115 to the body 105 of the guitar 100 may be between about 0.125 inches and 1.125 inches. However, example embodiment are not limited herein.

In at least one example embodiment, the second convex curvature 506 may be larger than the first convex curvature 502 and the third convex curvature 510. In particular, the second convex curvature 506 may be more curved than either the first convex curvature 502 or the third convex curvature 510. In at least one example embodiment, the third convex curvature 510 may be greater than the first convex curvature 502 such that the third convex curvature 510 is more curved than the first convex curvature 502.

In at least one example embodiment, the cross-section of the neck 110 may include an imaginary fourth convex curvature 512. The imaginary fourth convex curvature 512 is illustrated in FIG. 5 by a dashed line. The imaginary fourth convex curvature 512 extends from the first edge 138 to the second edge 140 and overlaps with the first convex curvature 502 from the first edge 138 to the first point 504. In at least one example embodiment, the second point 508 may be about 0.072 inches from a tangent line 514 to the imaginary fourth convex curvature 512. In at least one example embodiment, the second point 508 may be about 0.079 inches from the tangent line 514 to the imaginary fourth convex curvature 512 for a cross-section of the neck 110 located at or around the first fret 135. However, example embodiment are not limited herein.. The tangent line 514 may be perpendicular to a normal line 516 that extends through the second point 508.

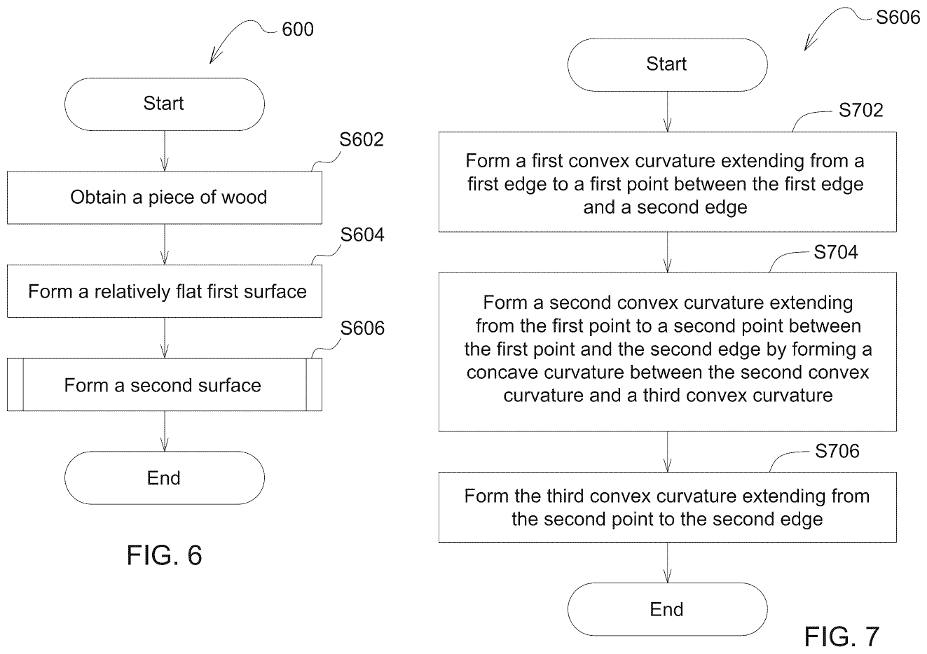

FIG. 6 is a flow chart of a method 600 of manufacturing a neck of a guitar. The method 600 is described herein with reference to the guitar 100 of FIGS. 1-5. The method 600 begins at S602 where a piece of wood is obtained. In at least one example embodiment, the piece of wood may be one or more pieces of wood. For example, one piece of wood may be used to form a fretboard and one piece of wood may be used to form a portion of the neck configured to couple to the fretboard to form the neck 110. In at least one example embodiment, the wood may be at least one of maple, such as roasted quartersawn flame maple, or mahogany. Alternatively or additionally, aluminum may be used instead of wood in at least some example embodiments. Obtaining the wood may include preparing the wood by letting it sit before proceeding with the method 600. For example, wood may shift or move when placed in climates with different levels of humidity. Thus, the wood should rest in a location for several days before manufacturing begins.

At S604, a relatively flat first surface is formed from the obtained wood. The relatively flat first surface may be the first surface 136 described above. In at least one example embodiment, the relatively flat first surface may be formed by running the obtained wood through a jointer and planer so the wood is relatively flat and of a uniform thickness. After the wood is relatively flat and of a uniform thickness, a computer numerical control (CNC) machine may be used to form the relatively flat first surface. The CNC machine may take code generated from a 3D model as an input and may form surfaces of a material in accordance with the code from the 3D model. Thus, the wood may be placed into the CNC machine and may have the first surface formed from code generated from a 3D model.

In at least one example embodiment, forming the relatively flat first surface may include forming a fretboard of the guitar 100. As described above, the relatively flat first surface may be formed with a CNC machine. Once the wood is shaped in accordance with the code from the 3D model, grooves may be formed in the relatively flat first surface. The grooves may be formed by a router, for example. The grooves may be formed in locations of the plurality of frets 134. After the grooves are formed, the plurality of frets 134 may be coupled to the relatively flat first surface for example via glue to complete the relatively flat first surface of the neck 110 of the guitar 100.

At S606, the second surface 142 of the neck 110 is formed. Similar to the first surface 136, a first step in forming the second surface 142 may be to run the obtained wood through a jointer and planer so the wood is relatively flat and of a uniform thickness. Then, a CNC machine may be used to form the second surface 142. In particular, the second surface 142 may be formed with a ball nose of a CNC machine such as a ½ inch ball nose that enables clearing operations and carving to be performed. A ⅜ inch end mill may also be used to form the second surface 142. Additional details of forming the second surface 142 are described with respect to FIG. 7.

In at least one example embodiment, the first surface 136 and the second surface 142 may be formed via two piece of wood that may be joined to form the neck 110 of the guitar 100. In at least one example embodiment, the piece of wood including the first surface 136 and the second surface 142 may be joined via glue, nails, or another method of coupling wood together.

FIG. 7 is a method 700 of forming the second surface 142. The steps of the method 700 may be performed with a CNC machine. As described above, the CNC machine may take code generated from a 3D model as an input and may form surfaces of a material in accordance with the 3D model. Alternatively or additionally, the second surface 142 may be formed with a router or other tool configured to alter a shape of the wood as described herein. At S702, the first convex curvature 502 is formed. As described above, the first convex curvature 502 extends from the first edge 138 to the first point 504.

As S704, the second convex curvature 506 is formed. The second convex curvature 506 extends from the first point 504 to the second point 508. In at least one example embodiment, forming the second convex curvature 506 may additionally include forming the second point 508 as a concave curvature between the second convex curvature 506 and the third convex curvature 510.

At S706, the third convex curvature 510 is formed. The third convex curvature 510 extends from the second point 508 to the second edge 140 as described above. Although the second point 508 is described above as being formed with the second convex curvature 506, the second point 508 may be formed as part of forming both the second convex curvature 506 and the third convex curvature 510.

The above-described guitars and methods provide improved guitars. In particular, the guitars described herein may be lighter weights which may improve user experience. Additionally, the guitar necks described herein are ergonomic and may improve a user experience when playing the guitar.

Example embodiments have been disclosed herein, it should be understood that other variations may be possible. Such variations are not to be regarded as a departure from the spirit and scope of the present disclosure, and all such modifications as would be obvious to one skilled in the art are intended to be included within the scope of the following claims.

We claim:

1. A guitar neck comprising:
a main body extending from a first end to a second end, a cross-section of at least one portion of the main body including
a first surface, the first surface being relatively flat and extending from a first edge to a second edge, and
a second surface extending from the first edge to the second edge, the second surface including a first convex curvature extending from the first edge to a first point between the first edge and the second edge, a second convex curvature extending from the first point to a second point between the first point and the second edge, and a third convex curvature extending from the second point to the second edge.

2. The guitar neck of claim 1, wherein the second point is located within a concave curvature between the second convex curvature and the third convex curvature.

3. The guitar neck of claim 1, wherein the cross-section of the at least one portion of the main body further includes an imaginary fourth convex curvature, the imaginary fourth convex curvature extends from the first point between the first edge and the second edge to the second edge, and the second point is about 0.07 inches from a tangent line of the imaginary fourth convex curvature, the tangent line being perpendicular to a normal line that extends through the second point.

4. The guitar neck of claim 1, wherein the second point is about 0.169 inches from the first point between the first surface and the second surface.

5. The guitar neck of claim 1, wherein the second point is about 0.4 inches from the first point between the first edge and the second edge.

6. The guitar neck of claim 1, wherein the first edge is proximate to where bass strings will be placed and the second edge is proximate to where treble strings will be placed.

7. The guitar neck of claim 1, wherein the at least one portion of the main body is proximate to a location of a first fret.

8. The guitar neck of claim 1, wherein the second convex curvature is larger than the first convex curvature and the third convex curvature and the third convex curvature is greater than the first convex curvature.

9. A guitar comprising:
a headstock;
a body; and
a neck including a main body extending from the headstock to the body, a cross-section of at least one portion of the main body including
a first surface, the first surface being relatively flat and extending from a first edge to a second edge, and
a second surface extending from the first edge to the second edge, the second surface including a first convex curvature extending from the first edge to a first point between the first edge and the second edge, a second convex curvature extending from the first point to a second point between the first point and the second edge, and a third convex curvature extending from the first point to the second edge.

10. The guitar of claim 9, wherein the second point is located within a concave curvature between the second convex curvature and the third convex curvature.

11. The guitar of claim 9, wherein the cross-section of the at least one portion of the main body further includes an imaginary fourth convex curvature, the imaginary fourth convex curvature extends from the first point between the first edge and the second edge to the second edge, and the second point is about 0.07 inches from a tangent line of the imaginary fourth convex curvature, the tangent line being perpendicular to a normal line that extends through the second point.

12. The guitar of claim 9, wherein the second point is about 0.169 inches from the first point between the first surface and the second surface.

13. The neck of claim 9, wherein the second point is about 0.4 inches from the first point between the first edge and the second edge.

14. The neck of claim 9, wherein the first edge is proximate to where bass strings of the guitar will be placed and the second edge is proximate to where treble strings of the guitar will be placed.

15. The guitar of claim 9, wherein at least one of the body includes one or more portions that are hollow or the headstock is slotted.

16. The guitar of claim 9, wherein the second convex curvature is larger than the first convex curvature and the third convex curvature and the third convex curvature is greater than the first convex curvature.

17. The guitar of claim 9, wherein the body includes a bass side and a treble side, the bass side being smaller than the treble side.

18. A method of manufacturing a neck of a guitar, the method of manufacturing comprising:
obtaining a piece of wood;
forming a first surface, the first surface being relatively flat; and
forming a second surface opposite the first surface by
forming a first convex curvature extending from a first edge to a first point between the first edge and a second edge,
forming a second convex curvature extending from the first point to a second point between the first point and the second edge, and
forming a third convex curvature extending from the second point to the second edge.

19. The method of claim 18, wherein forming the second convex curvature further includes forming a concave curvature between the second convex curvature and the third convex curvature.

20. The method of claim 18, wherein the second point is about 0.3 inches from the first point between the first edge and the second edge, about 0.169 inches from the first point between the first surface and the second surface, and about 0.07 inches from a tangent line of an imaginary fourth convex curvature, the imaginary fourth convex curvature extending from the first point between the first edge and the second edge to the second edge and the tangent line being perpendicular to a normal line that extends through the second point.
